(19) United States
(12) Patent Application Publication
(10) Pub. No.: US 2005/0240419 A1
(43) Pub. Date: Oct. 27, 2005

(54) Method, apparatus and program enabling a real estate network to acquire, filter and disseminate information

(76) Inventors: Jason Collins, Saskatoon (CA); Brendan King, Saskatoon (CA); John Fathergill, Saskatoon (CA); Jeff Tomlin, Saskatoon (CA)

Correspondence Address: POINT2 TECHNOLOGIES, INC., #500 - 3301 8TH STREET E, SASKATOON, SK, S7H 5K5, CA

(21) Appl. No.: 10/827,879

(22) Filed: Apr. 21, 2004

(51) Int. Cl. G06F 17/60

(52) U.S. Cl. 705/1

(57) ABSTRACT

A system is disclosed whereby a method, apparatus and program is developed that enables a real estate or other capital good network to acquire, filter and disseminate information seamlessly. Specifically, it is the object of the present invention to provide an apparatus, method and program whereby network members can input real estate listing and other related information on their network portal through the use of a terminal computer or other device, such information to be stored on the network through a central server computer, and such information for output to other network member portals where granted and requested.

### FIELD OF THE INVENTION

The present invention relates to an invention embodying a real estate network and, more particularly, to an apparatus, method and program for the creation and maintenance of electronic data in a central location from a remote client or terminal computer allowing the members of the Network to transfer and share such data with other members on the Network.

### BACKGROUND

Need Served

Unique, complex capital assets have numerous common types of characteristics, but substantial variation among those applicable characteristics for any given asset. The complexity is derived from the unique needs and desires of the end consumer of such assets. The end consumer needs to be able to acquire information about such assets in order to make buying decisions.

As a result, there is a need to rationalize the acquisition, filtering and dissemination of real estate listing and other related information (a unique, complex capital asset) that better enables the consumer to make buying decisions in a timely and effective manner.

By satisfying this need, increased efficiency is realized in real estate transactions by enhancing the ability of the potential homebuyer to acquire rich, applicable information or data on prospective complex, unique capital assets.

The satisfaction of this requirement would allow the potential homebuyer to increase the pace at which they cross the home buying spectrum, beginning at consideration to completion of the purchase of a house or other complex, unique capital asset. The rich, timely information accelerates the pace at which consumer and sellers can make transaction decisions.

In order to satisfy this requirement, a tool or capacity that enables the acquisition of information about the complex, unique capital asset is required that, once such information is acquired and entered, automatically disseminates that information to the seekers of such information. The seekers of such information are most often the ‘potential buyer’ of that class of complex, unique capital asset but can include other information stakeholders.

The invention is derived from the development of such a system in the real estate industry but can be extended to any other industry based upon the offer and sale of complex, unique capital assets.

Current State

In the real estate industry, there have been a number of inefficient, ineffective solutions to the problem of providing information to the information stakeholder. These include Multiple Listing Services and other information aggregators.

Current systems acquire the information in a simple, non-rich format from the information acquirer, most often the real estate agent or broker, and then provide a system or layer for consumers to browse and search the information in the system. The inefficiency lies in the disjoint between the acquirer of the information and the disseminator resulting in difficulties with the consistency and structure of the information that exists on the system. The information acquirer lacks an incentive or mechanism to facilitate the acquisition and input of the information into the system in a rich format. This results in an inability to provide timely, relevant information to information seekers.

This is problematic because the input and dissemination of the information is not seamless due to inconsistencies. The limited uniformity with respect to information format results in the inability for the information acquirer to enter the information once in their own system for their own purposes and then leverage it automatically to a single access point or central storage for seekers of relevant, timely information from multiple information acquirers. This creates a disjoint and therefore only patches between systems are available to satisfy the information seekers desire for a single access point for such real estate industry information. The lack of incentive for information acquirers to provide information in a standard, rich format results in a ‘lowest common denominator’ effect with respect to the richness of information that can be provided to information seekers on such a system. Therefore information is not of a sufficient ‘grain’ or relevance to act as a catalyst for potential capital asset purchasers to make buying decisions.

Ultimately, these issues result in an inability to provide maximum value to potential homebuyers or real estate professionals, these being the primary consumer of information output and acquirer of information respectively in such a system. As a result, the system cannot thrive because incentives are misplaced and the information cannot be efficiently consolidated and disseminated.

A system must lower the cost, both in terms of time and money, to get the information in the system and then have the ability to put the most applicable, relevant information in front of the potential homebuyer in a format and grain that is of a sufficient quality for the consumer to make buying decisions. The value of any system will be directly and highly correlated with this requirement.

Future State

A real estate system or network is envisioned that allows the easy, seamless input by the information acquirer of real estate listing and other related information of sufficient grain and format. After input, the system stores and updates information so it can be leveraged and disseminated to information seekers enabling an as ‘optimal as possible’ match between capital asset inventory and capital asset purchaser, thereby maximizing and increasing the value that the network brings to stakeholders.

This system would allow information seekers to immediately or soon thereafter know when applicable, relevant capital assets are available on the network that meet their specific needs and desires or the ability to browse rich information on capital assets. This contrasts with the current state where they are forced to browse or search listing information that is ‘low grain’ or non-rich and as a result, substantially limiting the ability to make buying decisions.

The system must be developed to provide an incentive for the information acquirers to enter the information on the network. In the real estate industry, this incentive can be achieved through a system that generally allows the capital asset information owned by the information acquirer to achieve maximum exposure and by providing the ability to allow other users or members of such a system, most often real estate agents and brokers, to disseminate such capital asset information to their clients and other market segments.

Enabling Trends and Technologies

The future state of the industry is enabled by the following developments and technologies:
ASP.NET Technology
   This technology allows a providing entity to provide portals or websites to acquiring entities whereby the acquiring entities access and manipulate such portals by connecting to the providing entities central servers.
Bandwidth
   The rapid and continued growth in the ability to transfer information accurately and quickly without traditional geographical constraints.
Connectivity
   The global population is becoming increasingly connected to the Internet both generally speaking and with respect to stakeholders of the complex, unique capital asset industries.
Increasingly tech-savvy information acquirers
   Those connected to the Internet that acquire complex, unique capital asset information over it are becoming increasingly capable of using technology to acquire and manipulate that information in an electronic format.
Increasingly tech-savvy consumers
   Those connected to the Internet that are seeking information about complex, unique capital asset information are becoming increasingly demanding of the quality of the information provided to them about such assets and expect efficient ways to acquire that information. These consumers of information expect tools that effectively match their needs and wants with the characteristics of the capital assets they seek. Additionally, they expect the ability to review fewer assets that do not conform to their specific needs and wants.

Current Limitations Imposed on Trends and Technologies

Current solutions are not comprehensive scope solutions (one system for information acquisition through to information dissemination) required to make the system seamless. The current systems attempt to patch together numerous and different systems of information acquisition, filtering and distribution resulting in inaccuracy and inconsistency. These imperfections are due to technological fragmentation and human error resulting from non-constructive flexibility and vagueness in the information acquisition, information filtering and information seeking processes. This lends itself to lags and errors in information input, shortcomings in the ability to filter queries submitted by information seekers and improper or ineffective information being disseminated.

Current solutions do not enable stakeholders to efficiently act in their best interests. The overall system has been patched together and with each advance in human demands and/or expectations and technological capacities these patches ‘tear’ and result in disenchantment for the ultimate stakeholders of such systems, the information acquirers and information seekers

Desirable Solution to Limitations

A system is required where information can be seamlessly inputted in a rich format, filtered with sufficient grain and disseminated near-instantaneously to those requiring such information.

Specifically, the system must provide tools to information acquirers so that information can be inputted in an attractive format that embodies a clear information acquisition process enabling the delivery of highly applicable information to those seeking such information.

Such system would overcome problems existing in the current ‘patch-work’ systems used to address the comprehensive scope required to optimally satisfy the stakeholders of complex, unique capital asset information.

Difficulties exist in achieving balance between enabling trends and enabling technologies. As information acquirers and information seekers become more demanding with respect to the tools and performance of such system, these demands must be satisfied to ensure usage. Any developer of such a system must balance the expectations of individual stakeholders with the demands of all stakeholders to ensure that the current capacities of the enabling technologies are sufficiently allocated.

### SUMMARY OF THE INVENTION

Objective

The general object of the invention is to develop a method, apparatus and program that enables a real estate or other capital good network to acquire, filter and disseminate information seamlessly.

Specifically, it is the object of the present invention to provide an apparatus, method and program whereby network members can input real estate listing and other related information on their network portal through the use of a terminal computer or other device, such information to be stored on the network through a central server computer, and such information for output to other network member portals where requested.

Components

Apparatus

The apparatus of the present invention, being an apparatus for the upload, download and storage of real estate listing and other related information, comprises a central server computer where real estate listing and other related information is stored; at least two terminal computers, said terminal computers being adapted for communicating with said central server; said terminal computers connecting to a network portal residing on said central server for the purpose of adding real estate listing and other related information that meets a given information format and/or structure, said real estate listing and other related information then being transmitted to the central server computer for storage; and said information being transmitted to a terminal computer via a network portal.

The Internet or other communications medium could connect the central server computer and the terminal computers. The network portal would be accessed via the terminal computers interaction with the central server over the Internet.

Any number of terminal computers could be used in conjunction with the central server computer.

The central server allows central storage of real estate listing and other related information that is uploaded by information acquirers through terminal computers and disseminates such information when called upon by network portals.

Terminal computers act as the platform from which network portals can be:
Accessed by portal owners and other individuals where information is inputted and uploaded to the central server computer; and
Browsers to call on the central servers to download or disseminate the information to those network portals for viewing by information seekers.

The central computer is required to ensure that the information uploaded by an information acquirer through a network portal is stored in a central location that supports a standard information format and maximizes the speed at which such information can be uploaded and downloaded when required.

Use of a central computer for real estate listing and other related information helps ensure maximum ‘up-time’ for the network by allowing the development of redundancy measures at one central point versus multiple periphery points on the network as would be the case if the network components were hosted primarily on member terminal computers. This structure helps ensure consistency and rationalization of the information residing on the network.

The central computer hosts the network portals utilizing Microsoft ASP.net technology so members can access their portals by calling the central server from a terminal computer.

The terminal computers are required to allow network access to stakeholders from any geographic location for both uploading and downloading real estate listing and other related information by calling network portals residing and hosted on the central server.

The program allowing the central computers to connect or interact with the terminal computers is installed on the central server computer or the terminal computers and thereby facilitates communication between the terminal and central computer over the Internet or other communication to ensure near-instantaneous dissemination of required information immediately upon entry to the network portal on the terminal computer.

Other devices may be used in place of or in addition to terminal computers to communicate with the central computer in the same or similar ways that the terminal computer. The other devices may include, but are not limited to, devices including:
PDA's;
Tablets;
GPS technologies; and/or
Cellular phones.

Method

The method behind the invention ensures real estate listing and other related information can be easily inputted by the information acquirer and then uploaded to the central server or other central storage location for said real estate listing and other related information through a network portal accessed by a terminal computer.

The method to upload information may include any pre-determined format or structure for input of real estate listing and other related information.

All uploaded network information by the information acquirer is stored on the central server and disseminated to those desiring the stored information. Desire for stored information could be determined by a request for information to the central server through a network portal on a terminal computer or other device. The information may be acquired by an information seeker through a network portal as a result of a number of requests including:
A search or query entered in the network portal from a terminal computer by an information seeker; and
A call or request by another network member who has an agreement with the network member who entered the applicable information and desires to display such information on his own network portal.

Information would then be returned to the requesting network portal for display on a terminal computer or other device through the requesting network portal.

The method would also allow the ‘Offering’ portal owner to choose to share certain information that they have inputted into the system with other ‘Receiving’ portal owners. The control of this relationship between the ‘Offering’ portal owner and the ‘Receiving’ portal owner could be very fine grained or very broad with respect to which information is shared or with which network portals it is shared. Such grain would be defined by the desired relationship between the owners of the applicable network portals.

Various information requirements or options may be included in the predetermined format or chosen from a pre-determined list to ensure sufficiently rich data is acquired about the specified raw real estate listing and other related information to enable the system to effectively respond to information requests. For example, real estate listing requirements might include price, dimensions of rooms, address, image resolution and image size, number of rooms, characteristics of rooms, property status and/or total square feet.

The method will ensure that stakeholders of the system gain maximum efficiency. Stakeholders will be connected by the invention and not rely on geographic, time, or other constraints to provide and acquire requirements integral to their real estate business process.

Program

The key and underlying requirement with respect to the program is to provide a communication mechanism that allows the central server and terminal computer or said other devices to communicate seamlessly and consistently with the central server through the network portals that are served from the central server and called on from terminal computers or other devices by network stakeholders.

The portal design must:
Allow for input to and display of output from the central server computer by accessing a network portal from a terminal computer or other device.
Provide the ability to share information between network portals enabling them to provide greater inventory to browse for visitors of network portals.

The central server operations must:
Ensure that real estate listing and other related information is received and allocated to memory on the central server computer in a structured format.
Ensure that the central server receives queries from network portals and responds to such queries accurately.
Facilitate listing sharing between network portals and ensure that relationships between network portals are stored and recognized so that applicable real estate listing and other related information can be disseminated where required.

The program could allow an offering network portal with real estate listing or other information entered into said network portal to communicate with a receiving network portal to display said information on the potential receiving network portal where the owner or administrator of the respective portals desire to establish such an arrangement.

This can be facilitated by a program that allows an offering network portal owner or administrator with real estate listing and other related information entered on their network portal to grant permission to such information or certain portions of such information to the receiving network portal owner on the network for display on that receiving network portal over the Internet or other communications medium. The receiving network portal owner can choose to display or reproduce such information on or may choose to block all or certain portions of such information from display on his or her network portal. This allows the receiving network portal owner to determine the optimal information to provide to his or her clients or visitors. The program could allow the offering network portal owner the ability to revoke the right for the receiving network portal owner to utilize such information at any time or based on some pre-determined period of time.

The program is required to implement the method on the apparatus thereby establishing the infrastructure for the described invention. More specifically, it is required to establish the network portals ability to input, filter and output real estate listing and other information on network portals as required or desired by Network stakeholders.

The program could acquire information about information seekers wants and needs with respect to the capital asset sought in order to better ‘understand’ what specific types of information the information seeker should be provided. This invention reduces the time required of the information seeker to satisfy their needs and wants for information by providing only the most relevant information.

The network as a whole can learn much faster and more efficiently than any individual, non-network program could learn about the needs of information seekers and how and when to satisfy those needs with system information and resources.

Additionally, by allowing network portals to share real estate listing and other related information with other network portals, the utility derived is maximized exposure of capital assets inventory, specifically real estate, to information seekers utilizing or visiting network portals.

The program acts as the interpreter and facilitator of commands from end users/stakeholders of the system or network.

The benefits to the network increase as each network portal owner establishes another relationship. Each new relationship represents greater potential information available on the network and an increased number of potential information seekers accessing such information.

The terminal program could be adapted to verify that the transmission of the information to the central server computer has taken place without errors. This may occur by having the central server computer send an error-free message to the applicable network portal. Optionally, if the transmission took place with an error, the portal program could be configured such that it would resend the corrupted data.

Information could be inputted through devices accessing network portals other than terminal computers.

These other devices could include, but are not limited to, tablet PCs, PDAs, cell phones and other devices that facilitate the upload and download of information to and from the central server by accessing a network portal.

How does the Invention Solve the Problem?

The program allows for rich real estate listing and other related information to be provided to potential homebuyers in a highly targeted, relevant way resulting in an ability to make better home buying decisions.

The resulting invention allows the acquisition, filtering and dissemination of real estate listing and other information leading to increased efficiency and effectiveness in the real estate selling and buying processes. The invention maximizes the value of the transaction by better matching complex, unique capital assets with the needs and desires of potential home buyers and as a result the asset is acquired by the optimal home buyer for that property.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a diagram of one embodiment of the apparatus of the present invention;

FIG. 2 is a diagram of an alternative embodiment of the apparatus of the present invention as in FIG. 1;

FIG. 3 is a diagram of an embodiment of the apparatus in network form of the present invention;

FIG. 4 is a diagram of an embodiment of the program that illustrates the network structure of the present invention;

FIG. 5 is an information flow diagram depicting the input of information to the network, the filtering of such information and the dissemination of the information as required.

FIG. 6 is an information sharing arrangement diagram depicting the potential sharing arrangements that may occur between network portals.

### DETAILED DESCRIPTION OF ILLUSTRATED EMBODIMENTS

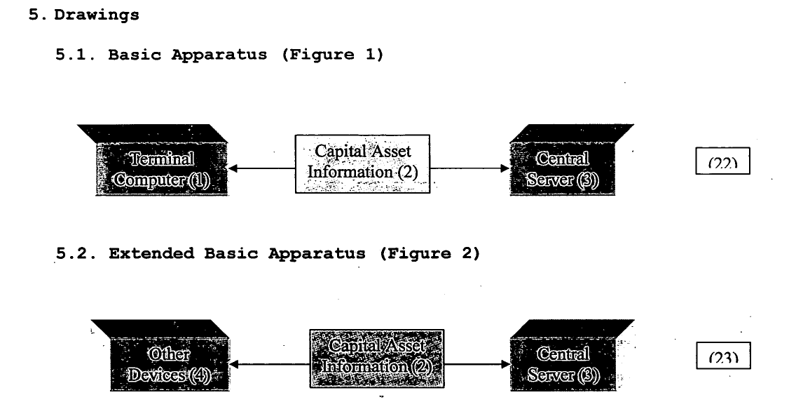

FIG. 1 is a diagram of one embodiment of the apparatus (22) of the present invention. In this embodiment, a central server computer (3) is linked up to at least one terminal computer (1). One terminal computer (1) is depicted in FIG. 1, but any number of terminals (1) could be used. Capital asset information (2), and potentially other types of information are passed between the terminal computers (1) and the central server (3)

The link between the terminal computer (1) and the central server computer (3) does not have to be a physical link. It can, for example, be a link via a modem, some type of a radio connection or any other link. An upload or download of a capital asset information (2) transaction can be initiated or responded to from any one of the terminal computers (1).

The system depicted in FIG. 1 may be embodied in hardware specifically provided to implement the present invention. Alternatively, the system may be implemented using the infrastructure that already exists in a particular company or for a particular user.

The central server computer (3) includes a Central Processing Unit (CPU) that performs the processing functions required. It also comprises a memory system. The memory system might include read-only memory (ROM), random access memory (RAM) and disc or other storage space. The ROM is used to store at least some of the program instructions that are to be executed by the CPU, such as portions of the operating system (BIOS). The RAM is used for temporary storage of data and a clock circuit provides a clock signal required by the CPU. The central server computer (3) as referred to herein means the combination of memory and storage devices used to retain data.

The central server (3) also includes a communications port that is used to communicate with devices outside of the server (3). In particular, the port facilitates communication between the server (3) and a terminal (1). The port might be a modem, a network connection, or some other method or apparatus allowing for the transmission and receipt of data by the server (3) to an external device.

FIG. 2 is a diagram of an alternative embodiment of the apparatus (23) of the present invention in FIG. 1. Other devices (4) can connect to the central server and form an alternative embodiment or additional embodiment of the apparatus. These devices may be able to perform the same, similar or other types of functions with respect to its communication of capital asset information with the central server (3). Some of the other devices (4) contemplated, but not limited to, include Notebook PC's, Tablet PC's, Global Positioning System Devices, Cellular Phones, and Personal Display Applications. Such devices provide different or greater potential flexibility and efficiency with respect to the acquisition and dissemination of capital asset information (2) on network portals (5).

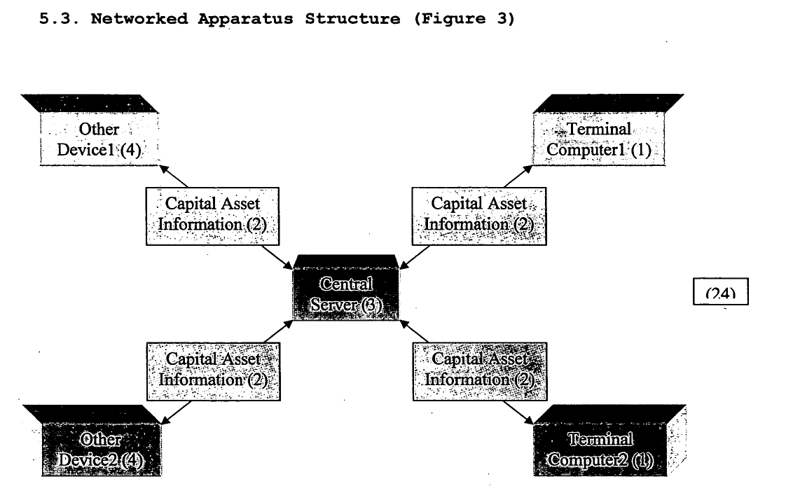

FIG. 3 is a diagram of an embodiment of the apparatus in network form (24) of the present invention. The network is formed by the interaction of multiple terminal computers (1) and other devices (4) with the central server (3). The network can have as many terminal computers (1) or other devices (4) connected to the central server as is required or possible to satisfy the acquisition, filtering and dissemination of capital asset information (2). The network apparatus structure depicted in FIG. 3 is not subject to geographic, time or other constraints that could limit the effectiveness of the invention to satisfy the requirements of the network stakeholders. For example, the network apparatus Structure enables stakeholders to communicate and information to be disseminated even when substantial geographic distances exist between stakeholders. Capital asset information (2) can be uploaded in one geographical area by a network stakeholder and near-instantaneously; a Network stakeholder in another geographical area can view that information if desired or relevant.

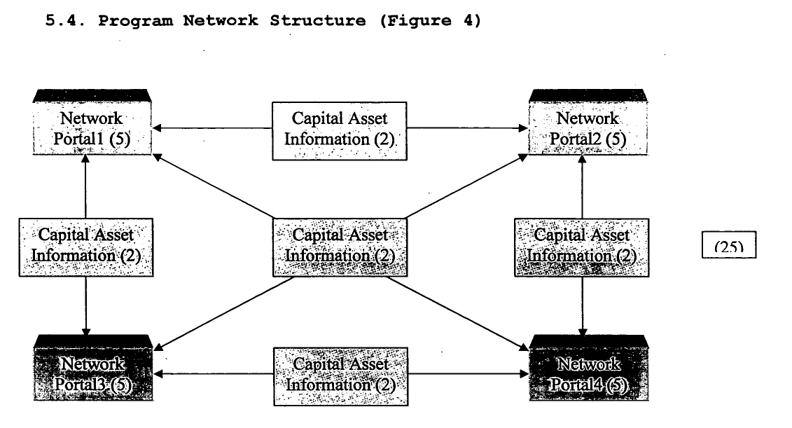

FIG. 4 is a diagram of an embodiment of the program that illustrates the network structure of the present invention. Network portals (5) are hosted on the central server (3) and accessed by stakeholders through terminal computers (1) or other devices (4) that access any applicable network portal by requesting such from the central server (3). Network portals (5) are enabled to communicate capital asset information (2) and other related information to any other network portal (5) residing on the central server (2). The network structure (25) is configured such that any capital asset information (2) entered onto the network is owned by the network portal where the information is first inputted but such information is potentially available for use or to be displayed on any other network portal.

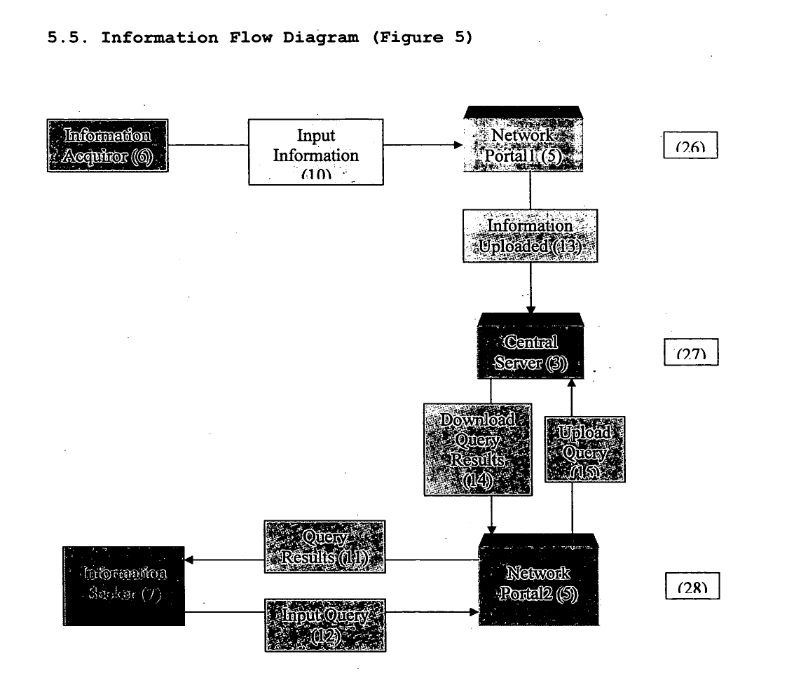

FIG. 5 is an information flow diagram (26, 27, 28) depicting the input of information to the network, the filtering of such information and the dissemination of the information as required. At (26) in FIG. 5, the information acquirer(s)(6) act(s) through a terminal (1) or other device (4) to access a network portal (5) residing on the central server (3). The information acquirer(s), using the tools and functions of the network portal, input(s) capital asset and other related information (10). The network portal (5) then uploads such information (13) to the central server (3) for storage in a predetermined format.

At (28) in FIG. 5, the information seeker (7) acts through a terminal (1) or other device (4) to access a network portal (5) residing on the central server (3). The information seeker (7) inputs a query or request on the network portal for information that may reside on the central server by virtue of the activity at (26). The network portal (5) then communicates with the central server (3) by uploading the query or request (15) to the central server.

At (27), the central server (3) would process such query or request (15) from the network portal (5) against the specific characteristics of the information previously uploaded (13) at (26) by the information acquirer(s). If information is found by the central server (3) that matches the query or request, such information is downloaded (14) by the network portal (5) and the query results (11) are displayed on the network portal (5) or is provided to the information seeker (7) in some other manner and/or medium.

If information is not found that matches the query or request (15), the central server (3) may store said query or request for the purpose of attempting to match it with capital asset information that is entered onto the network through the process at (26) at a time after such query or request is made. Once a match is found, the information would be sent or displayed to the information seeker (7) as described above.

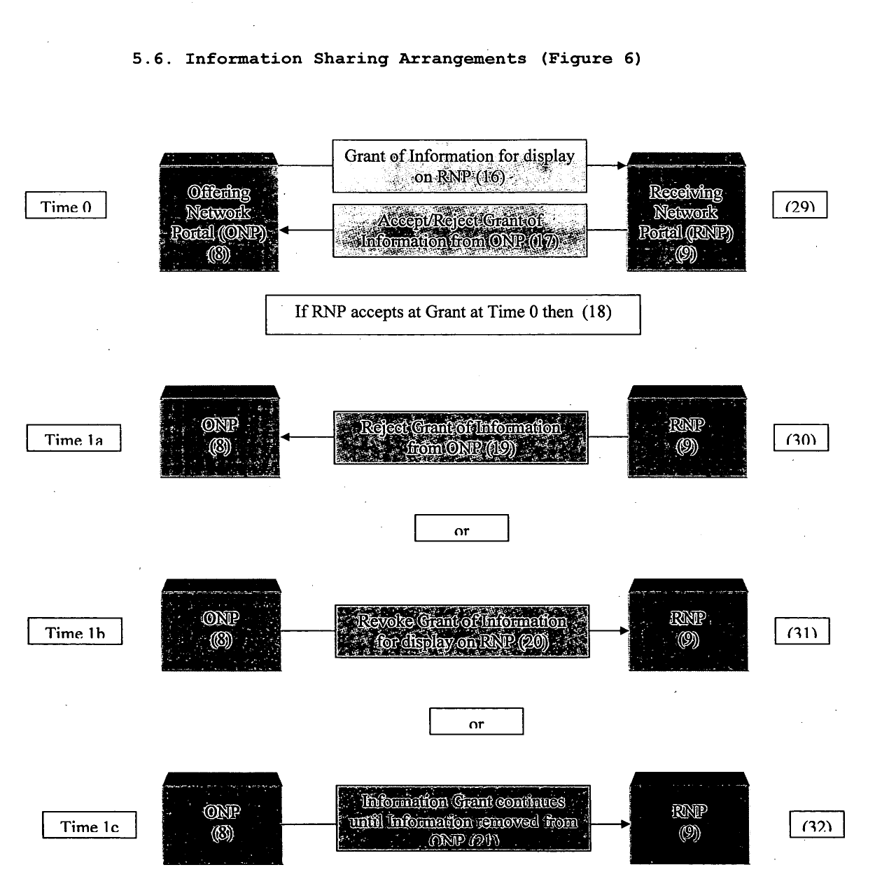

FIG. 6 is a real estate listing and other related information sharing arrangement diagram depicting the potential information sharing arrangements that may occur between network portals. The Offering Network Portal (ONP) (8) is assumed to have previously uploaded information and the central server has ascribed ownership status of such information to said ONP. At (29), the ONP offers or grants the information (16) owned by ONP to the receiving network portal (RNP) (9). This grant is communicated to the RNP (9) via a notification displayed on the RNP (9) or through some other manner or medium that the RNP owner receives. Upon receipt of said communication of the grant, the RNP owner has the option to either accept or reject the grant of the information from the ONP (17). This acceptance or rejection could be communicated to the ONP owner via a notification displayed on the RNP (9) or through some other manner or medium that the RNP owner receives.

In the event that the RNP (9) has accepted the grant of information at Time 0 (18), the relationship of information display between the ONP (8) and the RNP (9) may end at a future time with the occurrence of any of three events.
The first event, depicted in FIG. 6 as ‘Time 1a’ (30), occurs where after Time 0, the RNP (9) decides that the grant of information (16) is no longer desirable and thereby rejects the grant of information from ONP (19) at time 1a. Notification of said rejection is then delivered to the ONP and the relationship with respect to the sharing of said information is terminated.
The second event, depicted in FIG. 6 as ‘Time 1b’ (31), occurs where after Time 0, the ONP (8) decides that the grant of information (16) is no longer desirable and thereby rejects the grant of information to RNP (20) at time 1a. Notification of said rejection is then delivered to the RNP and the relationship with respect to the sharing of said information is terminated.
The third event, depicted in FIG. 6 as ‘Time 1c’ (32), occurs where after Time 0, the ONP (8) decides that the capital asset information should be removed (21) from the system due to obsolescence, irrelevance or any other reason and thereby the grant of information to RNP at time 0 is automatically revoked by the system.

1. A program whereby multiple instances of the program form a network structure allowing for seamless, remote input and output of real estate listing and other related information to and from the central server by network stakeholders.

2. The program of claim 1. wherein the program is manifested as a network portal.

3. A method whereby an information acquirer or multiple information acquirers can input real estate listing and other related information through some mechanism onto the real estate network into a central storage container and said information can be queried by and returned to information seekers through said mechanism.

4. The program of claim 1. whereby one network portal (the ‘offering network portal’) that has inputted, and thereby owns, real estate listing and other related information residing on the network can grant to another network portal (the ‘receiving network portal’) the ability for the receiving network portal to accept said grant and display said information on that network portal to information seekers.

5. The program of claim 4. wherein the receiving network portal has the ability to reject the grant of said information at the time of the grant or at some later time.

6. The program of claim 4. wherein the offering network portal has the ability to reject the grant of said information to the receiving network portal at any time after the grant is made.

7. The method of claim 2. whereby said information manipulation can be restricted to specific geographic regions, regardless of size.

8. The method of claim 2. whereby the acquirer or owner of information residing on the network can control where, when, how, and to whom the information is output or displayed when desirable to provide the option to restrict such distribution.

9. The program of claim 1. whereby the network portal is comprised of or possesses tools that allow information acquirers to input and upload real estate listing and other related information to the central server, with pre-defined information formats to ensure rich-data and consistency.

10. The program of claim 1. whereby the network portal is comprised of or possesses tools that allow information seekers to query the real estate listing and other related information residing on the central server, with pre-defined query formats to ensure rich-data and consistency.

11. The program of claim 1. whereby the network portal is comprised of or possesses tools that allow for the display of real estate listing and other related information returned from queries to the central server.

12. The program of claim 1. whereby the offering network portal can grant any information about a single real estate listing to a receiving network portal.

13. The program of claim 1. whereby the offering network portal can grant information owned by the offering network portal to a single or specific receiving network portal.

14. The program of claim 1. whereby the offering network portal can grant information owned by the offering network portal to a specific group of receiving network portals such as a real estate franchise or brokerage.
